(19) United States
(12) Patent Application Publication
(10) Pub. No.: US 2002/0023300 A1
(43) Pub. Date: Feb. 28, 2002

(54) Liquid-filled, tube style, shock inverter/seat cushion

(76) Inventor: Arthur Lagrant Stanley, E.St. Louis, IL (US)

Correspondence Address: Arthur L. Stanley, 2918 Trendley Ave., E.St. Louis, IL, 62207, US

(21) Appl. No.: 09/901,915

(22) Filed: Jul. 10, 2001

Related U.S. Application Data
(60) Provisional application No. 60/217,390, filed on Jul. 11, 2000.

(51) Int. Cl. B68G 5/00; A47C 16/00; A47C 20/02

(52) U.S. Cl. 5/654

(57) ABSTRACT

A liquid-filled tube-style shock inverter/seat cushion includes a primary base/surface panel made of an appropriately resilliant, thin-gauged rubber or rubber like material which is folded over from each end and joined by a secondary connecting strip made of the same material as the primary base/surface panel, so as to form an oval-shaped tube, which will expand and retract when acted upon by any force or motion. Two (2) side panels made of the same material as the primary and secondary panels, one of which has a fill/evacuate valve located in its center near the bottom; both of which having a diameter slightly larger than the diameter of the opening in each end of the oval-shaped tube, so as to have an outward-protruding ridge when inserted into and sealed to the oval shaped tube which is then filled with the appropriate amount of liquid, which regulates the motion, and the speed of motion in which this invention contours and re-contours, when acted upon by any force or motion, so as to cushion and invert a rough, undesirable ride or sitting into a more pleasurable ride or sitting sensation to a user. This invention also provides the cooling sensation of coming into contact with liquid, by means of a thin-gauged rubber or rubberlike material which contains its liquid fill.

This application claims the benefit of U.S. provisional application No. 60/217,390 filed on Jul. 11, 2000.

### BACKGROUND OF THE INVENTION

1. Field of the Invention

This invention relates to a liquid-filled, tube style, shock inverter/seat cushion, more particularly a liquid-filled shock inverter/seat cushion which is made in an open-bore, tube style which is made of a thin-gauged rubber or rubberlike material which has a liquid content capacity of 7.57 liters or (2) two U S gallons and may include a fill/evacuate valve, and which has a simple and inexpensive design, which provides great comfort to its occupant by means of its liquid content which is contained in its thin, durable and appropriately flexible rubber or rubberlike material, and which provides a more desirable ride sensation, as opposed to the rough ride associated with travel in a commercial motor vehicle, by means of allowing its occupant to move with fluid motions and re-contour with fluid motions as it inverts the shock caused by hitting bumps, dips or just the factor of the weight of a vehicle times the speed at which it travels, into a more desirable ride sensation, and also provides for a user the cooling sensation of liquid by means of its thin-gauged rubber or rubberlike surface which allows its occupant to feel the sensation of coming into contact with its liquid content which when used with air conditioning, helps to cool externally and internally, and which, all of said benefits are activated simply by placing this said invention into position and positioning one's self upon it. This invention may be used for general seating pourposes, automotive and general transportation seat cushioning, but is designed mainly for commercial motor vehicles.

### SUMMARY OF THE INVENTION

The main objective of this invention is to provide a liquid-filled shock inverter/seat cushion, which is made on an open-bore, tube style and which is made in a simple and inexpensive design which is made from an appropriately flexible rubber or rubberlike material, and which has a liquid content capacity of 7.57 liters or (2) two US gallons, which provides comfort, a more desirable ride sensation and the cooling sensation of coming into contact with liquid, which when used with air conditioning, will radiate a internal cooling sensation to its user. And, by means of its thin and appropriately resilient consistency and liquid content, this invention will inherently contour to its occupant, flex and re-contour with fluid motion, which inverts shock (caused by travel upon rough road surfaces) into a more desirable ride/seating sensation. The said cooling sensation of coming into contact with liquid is attained through coming into contact with a thin-gauged, durable and appropriately flexible rubber or rubberlike material which is used to contain the liquid content of this invention, which also, when acted upon by any force or motion, produces the soothing sound of splashing water, which can offset the monotonous noise of an engine's drone, for a user.

According to this invention, a liquid-filled, tube style shock inverter/seat cushion includes a base/seating rubber or rubberlike material, two side-panels which are made of the same material as the primary and secondary strips, one of which includes a fill/evacuate valve, all of which are joined/ sealed to form a sealed tube type unit which is then filled with liquid, and when sat upon, the surface will inherently contour its occupant, and when acted upon by any force or motion, this invention will allow the occupant to motion so as to avoid any damaging impact that may otherwise occur as a result of any said occurring force, while providing comfort. The thin-gauged base/surface material allows the user to feel the cooling sensation of coming into contact with liquid, which when used with air conditioning, will radiate an internal cooling sensation to the user, and which, when acted upon by any force or motion, will produce the soothing sound of splashing water, which can offset the monotonous noise of an engine's noise.

### BRIEF DESCRIPTION OF THE DRAWING(S)

Other features and advantages of the present invention will become apparent in the following detailed description of the preferred embodiments of this invention, with reference to the accompanying drawings in which:

FIG. 1 is a partially sectional perspective view showing a liquid-filled, shock inverter/seat cushion of the first embodiment of this invention;

### DETAILED DESCRIPTION OF THE PREFERRED EMBODIMENTS

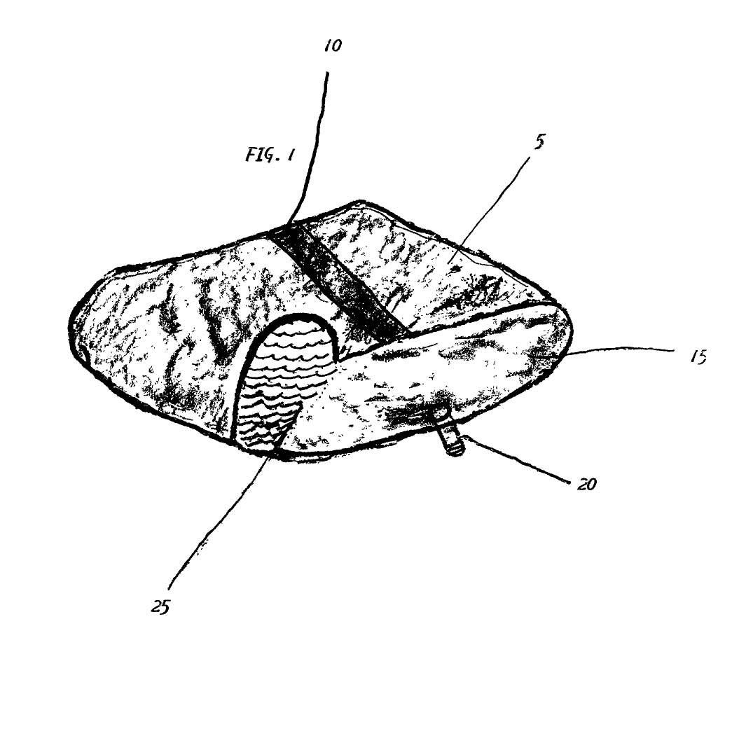

Referring to FIG. 1, a liquid-filled, tube style shock inverter/seat cushion 1 of the first embodiment of this invention includes a surface/base section/strip of rubber or rubberlike material 5, which measures (3) three feet wide by (1) one foot long, is folded over on each end so as to form an oval shape; each end is therefore butted against the other evenly and then attached/sealed with a secondary strip 10, thus forming an oval-shaped unit 5, The (2) two side panels 15, (one of which will have a fill/evacuate valve 20, located towards the lower center of a side panel 15. Each side panel 15, will exceed the diameter of the opening on each end of the oval-shaped unit 5, (by a small margin) so as to form an outward protruding ridge when put into place in each end of the oval-shaped unit 5, thus forming a sealed unit, in which a liquid fill 25, may then be added.

With this invention thus explained, it is apparent that numerous modifications and variations can be made without departing from the scope and spirit of this invention. It is therefore intended that this invention be limited only as indicated in the appended claim(s).

I claim:

1. A liquid-filled tube-style shock inverter/seat cushion including an appropriately resilient, thin-gauged rubber or rubberlike primary base/surface panel, a secondary connecting strip, (2) two oval-shaped side panels, one of which has a fill/evacuate valve located on its center near the bottom being made of rubber, and sealed thereto, and a liquid therein, which comprises:
said appropriately resilient, thin-gauged rubber or rubberlike primary base/surface panel, having been wire-brushed and cleaned;
said secondary connecting strip, also having been wire-brushed and cleaned;
said (2) two oval-shaped side panels, also having been wire-brushed and cleaned, one of the (2) two said oval-shaped side panels having:
a fill/evacuate valve located in its center near the bottom being made of rubber and sealed thereto; the primary base/surface panel, having been folded over from each end and having each end abutted against the other and then sealed by vulcanization to the said secondary connecting strip, so as to form an oval-shaped tube in which the (2) two said oval-shaped side panels, both having a diameter slightly larger than the diameter of the openings in each end of the oval-shaped tube, so as to have an outward-protruding ridge when sealed into place, are then inserted and sealed by vulcanization, which said oval-shaped tube being so designed, so as to have a simple and inexpensive design, and so as to expand and retract when any pressure is applied and then released, wherein said liquid fill is then added, wherein said liquid fill regulates the motion, and the speed of motion in which this invention contours and re-contours when acted upon by any force or motion, so as to cushion and invert a harsh, violent ride sensation into a smooth, more pleasurable ride or seating sensation to a user.

2. A liquid-filled tube-style shock inverter/seat cushion including an appropriately resilient, thin-gauged rubber or rubberlike primary base /surface panel, a secondary connecting strip, (2) two oval-shaped side panels, one of which has a fill/evacuate valve located in its center near the bottom being made of rubber and sealed thereto, and a liquid fill therein, which further comprises:
Said appropriately resilient thin-gauged rubber or rubberlike primary base/surface panel having been wire-brushed and cleaned;
said secondary connecting strip, also having been wire-brushed and cleaned; as to form an oval shape; each end is therefore butted against the other evenly and then attached/sealed with a secondary strip 10, thus forming an oval-shaped unit 5, The (2) two side panels 15, (one of which will have a fill/evacuate valve 20, located towards the lower center of a side panel 15. Each side panel 15, will exceed the diameter of the opening on each end of the oval-shaped unit 5, (by a small margin) so as to form an outward protruding ridge when put into place in each end of the oval-shaped unit 5, thus forming a sealed unit, in which a liquid fill 25, may then be added.
With this invention thus explained, it is apparent that numerous modifications and variations can be made without departing from the scope and spirit of this invention. It is therefore intended that this invention be limited only as indicated in the appended claim(s).
